(19) United States
(12) Patent Application Publication
(10) Pub. No.: US 2025/0282490 A1
(43) Pub. Date: Sep. 11, 2025

(54) AUTONOMOUS LATCHING SYSTEM

(71) Applicant: Elroy Air, Inc., South San Francisco, CA (US)

(72) Inventor: Matt Burke, San Francisco, CA (US)

(73) Assignee: Elroy Air, Inc., South San Francisco, CA (US)

(21) Appl. No.: 19/049,331

(22) Filed: Feb. 10, 2025

Related U.S. Application Data
(60) Provisional application No. 63/552,314, filed on Feb. 12, 2024.

(51) Int. Cl. B64D 45/00; B64D 9/00; F16M 13/02

(52) U.S. Cl. CPC B64D 45/0005; B64D 9/00; F16M 13/02

(57) ABSTRACT

An autonomously UAV mission pod latching system for the unattended or minimally attended performance of UAV mission includes mechanisms for securely attaching and detaching the pod to the UAV without the intervention of ground crew as well as verifying the state of each latching assembly. A plurality of sensors and switches at each point of contact between the vehicle and the pod convey data to a processor which thereafter determines the state of each latching assembly to confirm the pod is captured by the latching system and is secured to the UAV.

### RELATED APPLICATION

The present application relates to and claims the benefit of priority to U.S. Provisional Patent Application No. 63/552,314 filed 12 Feb. 2024 which is hereby incorporated by reference in its entirety for all purposes as if fully set forth herein.

### BACKGROUND OF THE INVENTION

### Field of the Invention

Embodiments of the present invention relate, in general, to systems and methods for autonomous latching and unlatching between an unmanned aerial vehicle (“UAV”) and an external mission pod, and more particularly to autonomous latching systems and methodology wherein a fully loaded pod may stay intact and attached to the UAV throughout the UAV flight envelope.

### Relevant Background.

UAVs, often referred to as drones, are well-suited to applications where a traditional manned aircraft could be used but the physical presence of a human operator or pilot is undesirable. For example, in circumstances where a human operator would face risks that cannot be mitigated, such as flight in poor weather conditions or in the presence of ground hazards such as radiation or toxic emissions, it is advantageous to use an autonomous or semi-autonomous vehicle. One particularly critical factor is pilot exhaustion or boredom where, during a long flight in relatively repetitive conditions, a human operator may become fatigued and fall asleep.

For these reasons, UAVs are often used by governmental organizations for several different missions previously performed by manned aircraft, to include cargo transport; supplemental power storage, intelligence, surveillance, and reconnaissance (“ISR”); command and control operations; and global strike missions. Specifically, there is a demand for UAV systems with increased carrying capacity. For example, the US military recently sought development of a UAV that could carry a LiDAR system having a diameter of 18-21 inches and weighing 200-300 pounds.

Many larger models of UAVs are expensive, costing in the hundreds of millions of dollars, and are typically adapted for specific missions. For example, most large UAVs used for ISR carry the necessary equipment in their fuselage, which makes it difficult to adapt them for other functions. Some of these disadvantages can be mitigated using a removably attachable mission pod. As used herein, a pod is a volume for carrying a payload that is mounted externally to an aerial vehicle's fuselage and is often aerodynamically shaped to reduce drag. Use of such pods allows the aerial vehicle to have a smaller fuselage, which increases the structural efficiency of the aerial vehicle by reducing its enclosed volume. Further, the use of a pod with an aerial vehicle improves the system's modularity and flexibility, i.e., a single fuselage is rendered compatible with many types of mission, as well as the use of diverse equipment types for similar missions.

While the advantages of a large UAV with an exchangeable external pod for housing mission equipment is apparent, the process of exchanging external pods threatens the autonomous nature of UAV operations. Existing systems and methods for installing and removing mission pods onto compatible UAVs require intensive involvement from ground crew, limiting the usefulness of such systems in forward deployed locations.

It is apparent that a need exists for an autonomously latching mission pod that is compatible for use with a large, multi-purpose UAV. As disclosed, the invention allows rapid and automated attaching and detaching of cargo pods to the aircraft, e.g., the Chaparral UAV, so that the aircraft can fly its cargo carrying mission without requiring human intervention. These and other deficiencies of the prior art are addressed by one or more embodiments of the disclosed invention. Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out hereafter.

### SUMMARY OF THE INVENTION

An autonomous latching system engages a cargo pod, container, or the like at a plurality of points of contact (latching assemblies) and secures the pod to a vehicle such as a UAV. A plurality of sensors and switches at each point of contact between the vehicle and the pod convey data to a processor which thereafter determines the state of each latching assembly and confirm the pod is captured by the latching system and is secured to the UAV.

According to one embodiment the autonomous latching system of the present invention includes a processor, capable of executing instructions embodied as software, a plurality of upper latching assemblies mounted to a vehicle such as an UAV, a plurality of lower latches affixed to a pod or cargo container or the like, and one or more software portions configured to determine the state of each latching assembly and within each latching assembly the presence of a lower latch component.

Each upper latching assembly of the present invention includes, in one embodiment, an upper latch cam, a striker cam, a first limit switch, and a latch sensor. The upper latch cam and the striker cam are rotatably coupled to a mounting plate and rotatably interact to form a dock. Responsive to the first limit switch interacting with the striker cam, the first limit switch sends a first limit switch signal to the processor of a closed dock configuration. Lastly the latch sensor sense the presence (position) of a component of the lower latch (in one embodiment the latch bearing) within the dock of an upper latching assembly.

Each lower latch of the present invention includes a latch bearing, a latch pin and, in one embodiment, a magnet proximate to the latch bearing. Responsive to the latch bearing interacting with the striker cam of an upper latching assembly, the striker cam and upper latch cam rotate to closed dock configuration capturing the latch bearing within the dock.

One or more software portions, executable by the processor, receive and process data from the one or switches and sensors associated with each upper latching assembly to determine whether the pod is secured to the vehicle with each of the plurality of upper latching assemblies in the closed dock configuration.

Other embodiments of the autonomous latching system of the present invention include a pair of springs interposed between the mounting plate and the upper latch cam and the striker cam that are biased to hold the striker cam and the upper latch cam in the open dock configuration.

The latch sensor of the present invention, in one embodiment, is positioned at an apex of the dock and wherein the latch sensor is a hall sensor. Responsive to the latch sensor detecting the latch bearing of a lower latch, the latch sensor sends a latch sensor signal to the processor that the latch bearing is proximate to the apex of the dock.

In another embodiment of the present invention the upper latch cam includes a recess. It is within this recess that responsive to the latch bearing interacting with the striker cam, the striker cam and the upper latch cam rotate and a portion of the striker cam is captured thereby locking the upper latching assembly in the closed dock configuration.

Another feature of each upper latching assembly of the present invention is a second limit switch that, responsive to the second limit switch interacting with the striker cam, sends a second limit switch signal to the processor of an open dock configuration.

Each upper latching assembly also includes, in another embodiment, an actuator. When the actuator interacts with an actuator cam the actuator cam rotates the upper latch cam to release the striker cam, and the upper latch cam, unlocking the upper latching assembly and placing it into an open dock configuration. A software portion is configured send a signal to the actuator to rotate a trigger cam and place each of the plurality of upper latching assemblies in the open dock configuration.

One of the software portions of the present invention is configured to determine, for each upper latching assembly, when upper latching assembly is in the closed configuration and the latch bearing is proximate to the apex of the dock while another software portions is configured to receive signals from each first limit switch, each the second limit switch and each latch sensor to confirm a status of each upper latching assembly and proximity of each latch bearing to determine if a cargo pod is secured to the UAV.

A methodology for autonomously latching a pod to a vehicle, according to one embodiment of the present invention, includes mounting a plurality of upper latching assemblies to the vehicle, affixing a plurality of lower latches to the pod, and determining whether the pod is secured to the vehicle.

The method includes forming, for each upper latching assembly, a dock by first rotatably coupling the upper latch cam and the striker cam to a mounting plate and thereafter rotatably interacting the upper latch cam and the striker cam.

Another step for autonomously latching a pod to a vehicle is positioning a latch sensor in each upper latching assembly to sense the presence of a lower latch within the dock of an upper latching assembly.

As indicated previously, each lower latch includes a latch bearing, a latch pin, and a magnet proximate to the latch bearing. When the latch bearing interacts with the striker cam of an upper latching assemblies and resides within the dock of that upper latching assembly, that upper latching assembly is placed in a closed dock configuration. A first limit switch concurrently interacts with the striker and sends to a processor a first limit switch signal of the closed dock configuration.

Software, executable by the processor, analyzes data from the first limit switch and the latch sensor of each upper latching assembly do determine whether the pod is secured to the vehicle.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 depicts a front left quadrant view of a vertical take-off and landing (“VTOL”) UAV for use with a mission pod.

FIG. 2 depicts a right-side view of a UAV for use with a mission pod.

FIG. 3 depicts a front left quadrant view of a mission pod as used in embodiments of the disclosed invention.

FIG. 4 depicts a right-side view of a mission pod as used in embodiments of the disclosed invention.

FIG. 5 depicts a high-level block diagram of an autonomous latching system according to one embodiment of the present invention.

FIG. 6 depicts an exterior side view of an upper latch as used in embodiments of the disclosed invention.

FIG. 7 depicts an interior side view of an upper latch as used in embodiments of the disclosed invention.

FIG. 8 depicts an interior side view of a sensor rocker for the upper latch as used in embodiments of the disclosed invention.

FIG. 9 depicts an interior perspective view of an upper latch as used in embodiments of the disclosed invention.

FIG. 10 depicts an exterior perspective view of an upper latch as used in embodiments of the disclosed invention.

FIG. 11 depicts an exploded view of an upper latching assembly according to one embodiment of the present invention.

FIG. 12 depicts an interior perspective view of a lower latch as used in embodiments of the disclosed invention.

FIG. 13 depicts a perspective view of an upper latch shown in context of the UAV as used in embodiments of the disclosed invention

FIGS. 14A and 14B present a flowchart depicting one methodology for autonomous latching according to the present invention.

FIG. 15 is a high level system diagram of a computing system as would be used and employed in one or more embodiments of the present invention.

The Figures depict embodiments of the present invention for purposes of illustration only. Like numbers refer to like elements throughout. In the figures, the sizes of certain lines, layers, components, elements or features may be exaggerated for clarity. One skilled in the art will readily recognize from the following discussion that alternative embodiments of the structures and methods illustrated herein may be employed without departing from the principles of the invention described herein.

### DESCRIPTION OF THE INVENTION

An autonomously or automatically UAV mission pod latching systems and methods for the unattended or minimally attended performance of UAV missions is hereafter described. The disclosed mission pod having mechanisms for securely attaching and detaching the pod to the UAV without the intervention of ground crew.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used to autonomously latch a pod to a vehicle. In the following description, it will be understood that one or more blocks of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware, hardware-based computer systems that perform the specified functions or steps, or combinations of special purpose hardware and computer instructions.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

### Mission Pod Compatible UAV

Collectively, patent applications U.S. Ser. No. 16/172,470 (“Compound Multi-Copter Aircraft”), U.S. Ser. No. 16/227,400 (“Unmanned Vehicle Cargo Handling and Carrying System”), and U.S. Ser. No. 17/070,037 (“Mission Pod for Unattended UAV Operations”) disclose UAVs and mission pods for transporting a cargo payload and are incorporated by reference herein. The disclosed invention concerns systems and methods for autonomously latching a mission pod to a UAV to allow unattended or minimally attended UAV operations. In particular, the invention provides mechanisms, systems, and methods for facilitating unattended mounting between the UAV and pod.

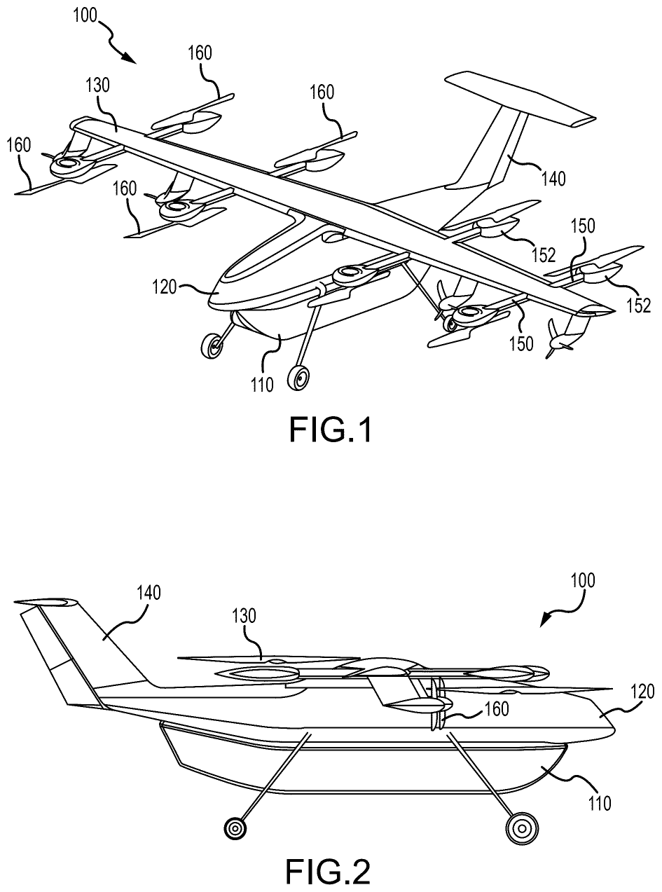

With reference to FIGS. 1 and 2, a VTOL UAV with mission pod, representative of a vehicle employing the autonomous latching system of the present invention, is depicted. The UAV 100 includes a fuselage 120, wing 130, T-tail 140, propellers 160, and mission pod 110. U.S. 62/832,710, incorporated by reference herein, describes various embodiments of pod 110, and U.S. Ser. No. 16/227,400 discloses means by which fuselage 120 aligns with, attaches to, and detaches from pod 110.

FIG. 1 illustrates a UAV with four booms 150 attached to wing 130, two on either side of the fuselage 120, with two motor pods 152 attached to each end of the four booms 150. Each motor pod 152 includes a motor and a rotor. The motor pods 152 enable the VTOL functionality of the UAV. In one embodiment, the fuselage of the UAV contains electrical power storage in the form of batteries, electronic equipment such as computing and battery management systems, and fuel used to power an internal combustion engine, which is equipped with a propeller to produce forward thrust, and a generator to supply electrical power for use by vertical thrusters.

Instead of having interchangeable mission pod 110, the UAV could be fitted with a standard aircraft pod, such as the U.S. military's “AgilePod,” which is equipped to carry ISR equipment. However, use of the UAV with a standard pod would require the use of an adapter, preferentially one configured to work with a grasper-type crane, as described in U.S. Ser. No. 16/227,400 (“Unmanned Vehicle Cargo Handling and Carrying System”). Further, since existing pods are usually purpose-built for their specific mission, conducting diverse missions with the UAV will require use of different pods, each of which will likely have its own compatibility issues with the UAV. The use of existing pods, therefore, would make changing missions more difficult, and require intervention from ground crews to reconfigure the UAV or pod. Additionally, existing pods retain features unnecessary for UAV use, such as the ability to withstand supersonic flight speeds. Such unnecessary features degrade the mission capabilities of the UAV, such as by increasing pod weight, increasing power consumption, reducing available space, and so on. Therefore, a key to the disclosed invention is use of a mission pod or container that can accommodate diverse missions, or that can be readily re-purposed for ISR, cargo, command and control, or global strike missions.

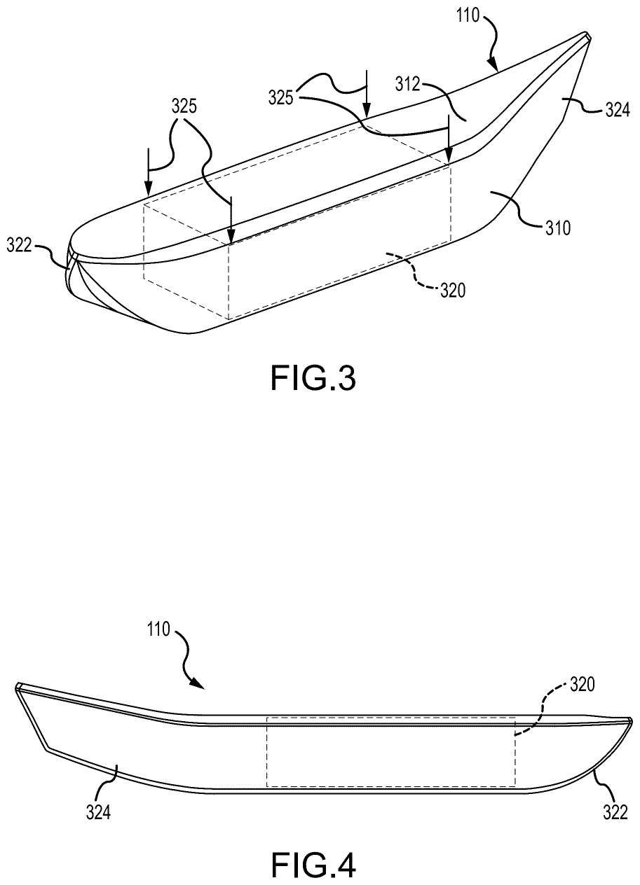

Accordingly, with reference to FIGS. 3 and 4, the disclosed invention includes the mission container or pod 110 that a UAV is configured to carry. As described in U.S. 62/832,710 (“Aerial Cargo Container”), the container is substantially rectangular in shape, with either an open top (not shown) or a closed top 312 and is configured to be coupled to or decoupled from the underside of the UAV fuselage, as described in U.S. Ser. No. 16/227,400 (“Unmanned Vehicle Cargo Handling and Carrying System”).

The pod includes an outer shell 310, which may be configured in various ways to facilitate a specific mission type. For example, the outer shell may be solid and composed of carbon fiber, fiberglass, quartz, or other suitable strong and lightweight materials. The shell may be hardened to withstand bird strikes, and extremes in temperature and vibration. The outer shell 310 houses a payload section 320, which is a portion of the pod interior that is stressed for bearing loads and includes a plurality of hard points 325 suitable for securing the pad to a vehicle. A remaining portion of the pod includes a fore fairing 322, and an aft fairing 324, which provide an aerodynamic shape for the pod conformal with the lower UAV surface and provide additional space to house equipment.

### Mission Pod to UAV Interface

As disclosed in U.S. Ser. No. 17/070,037 (“Mission Pod for Unattended UAV Operations”), there are multiple alternative approaches for mating the mission pod to the UAV fuselage. These approaches share an overall structure of: (1) bringing the pod and aerial vehicle into rough initial orientation and alignment; (2) employing the grasping, winching, latching sequence as described in U.S. Ser. No. 16/227,400; and (3) establishing the connections required to transfer data, power and/or communications between the pod and UAV.

To enable rapid, unattended detachment, attachment and swapping of mission pods configured for different missions, the disclosed systems employs communication means between the mission pod and the UAV to achieve initial orientation and alignment. Such communication means may be a form of localized communication, such as wireless internet, cellular, optical communication, radio, or the use of ultra-wide band (“UWB”) radio transceivers. Each mission pod may be configured with one or more identifier beacons that can be received by a UAV located in range of the communication. Such an identifier conveys a specific serial number for the beacon. The beacon, in turn, is associated with a physical location on the pod, and may identify the pod and contents of the pod. In some embodiments, the beacon may identify the mission configuration of the pod, the power status, precise location, or other information useful for matching the pod with an appropriate UAV and mission. Sensors on the aerial vehicle are configured to detect the beacon arrangement on the pod, and from such information can infer information about the pod, such as position, orientation relative to the aerial vehicle, and pod identification.

### Autonomous Latching System

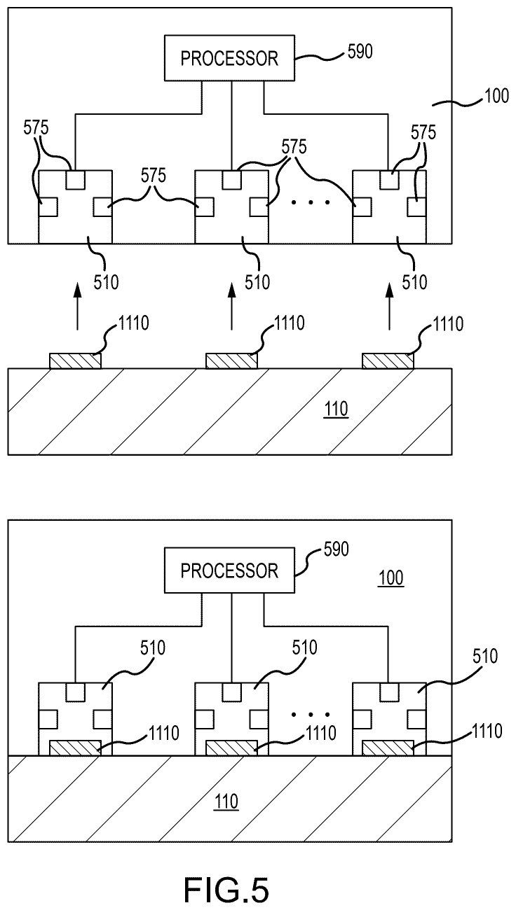

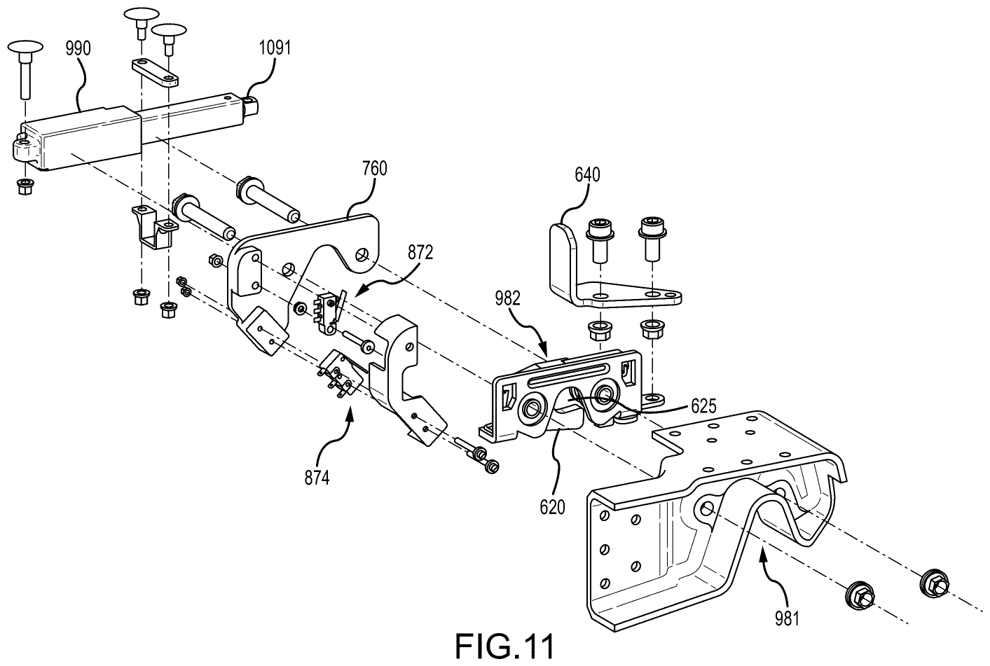

Once roughly aligned, the pod 110 and aircraft 100 are further aligned and secured together by a plurality of self-aligning latching mechanisms, e.g., four. FIGS. 5A and 5B depict a high level block diagram of a system for autonomous latching system according to one embodiment of the present invention. A plurality of lower latches or hasps (see FIG. 11, item 1210) are affixed to the pod 110 and each are aligned with a corresponding upper latching assembly 510 mounted to the vehicle (UAV) 100. Each upper latching assembly 510 includes a plurality of sensors 575 communicatively coupled to a processor 590 configured to determine, based on sensor input on the configuration of each upper latching assembly 510 and the presence of the lower latches, whether the pod 110 is secured to the vehicle 100.

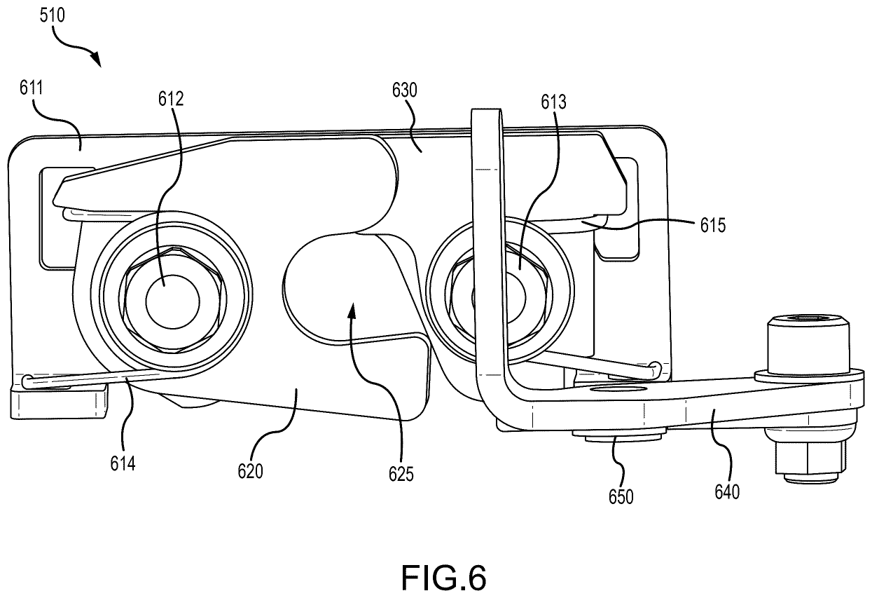

With additional reference to FIG. 6, an exterior side view of an embodiment of an upper latch 510, shown here without an upper latch mount for securing the latch to the UAV. Exterior here means facing away from the centerline of the UAV. Each upper latching assembly is positioned to mechanically interact with a corresponding lower latch mounted on/affixed to the pod. As the pod is pulled toward the UAV, the pod is aligned by the shape of the respective latching mechanisms before being secured for flight. With further reference to FIG. 3, the latch pairs may be located at the hardpoints 325 which correspond to the corners of the payload section of the pod. Other arrangements are possible and contemplated. The upper latching assembly 510 includes a mounting plate 611, a striker cam 620, and an upper latch cam 630 that are configured to mechanically interact with each other and create a dock 625 when in a closed position for securing to the lower latch assembly. In one embodiment, the striker cam and upper latch cam can rotate about two bolts 612, 613 that secure the cams to the mounting plate 611. A pair of springs 614, 615 are configured to hold (bias) the striker cam and the upper latch cam in an open position (open dock configuration) unless locked in a closed position (the closed position is shown). A set of limit sensors (see FIG. 8, items 872, 874) detect when the striker cam and upper latch cam are positioned in a closed dock position configuration. The upper latch also includes an actuator cam 640 configured to be operated by an actuator (not shown). The actuator cam mechanically interacts with the trigger cam 650 to release the striker cam 620 and upper latch cam 630 to allow the springs 614, 615 to move the cams to the open dock configuration.

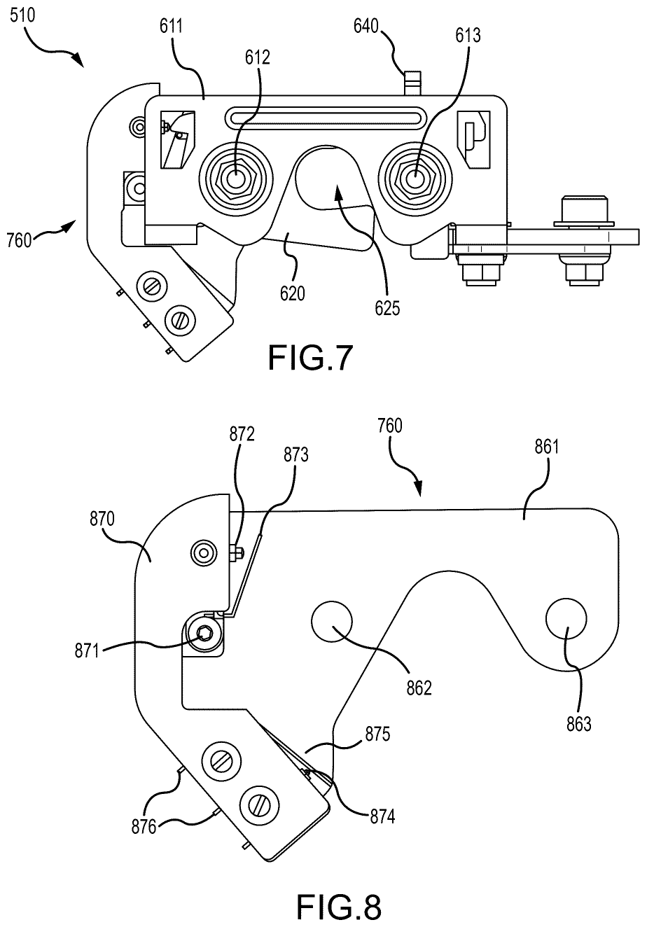

FIG. 7 shows an interior side view of an embodiment of the upper latching assembly 510, where interior means facing toward the centerline of the UAV. The bolts 612, 613 are visible, as are the striker cam 620, the dock 625, and the actuator cam 640. Also shown is a sensor mount 760. Additional reference to FIG. 8 shows an interior side view of the sensor mount 760 removed from the remainder of the upper bracket. The sensor mount 760 includes a mounting bracket 861, which includes holes 862, 863 for securing the sensor mount to the upper bracket. The holes 862, 863 are configured to mechanically interact with the bolts (see FIG. 6, items 612, 613 respectively) that secure upper bracket components. The sensor mount also includes first and second limit switches (respectively) 872, 874 to indicate the open or closed status of the latch. When the striker cam moves to the closed position, a portion of the striker cam activates a closed sensor 872 of the first limit switch by pressing an upper strike plate 873 into contact with the closed switch, thereby indicating the closed dock configuration. When the striker cam moves to the open position, it presses a lower strike plate 875 of a second limit switch into contact with an open sensor 874 to indicate the open dock configuration. The outputs of the first and second limit switches 872, 874 are transmitted to the processor 590 by a set of cables 876 attached to the sensor mount 760.

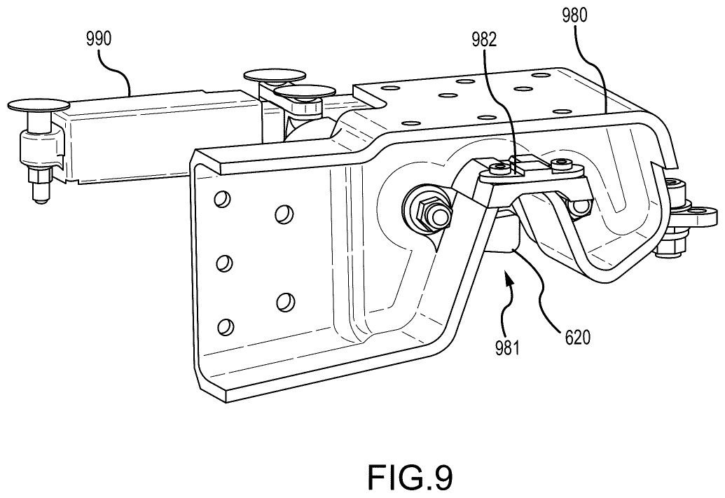

With reference to FIG. 9 is depicted an interior perspective view of the striker cam 620 associated with the upper latch cam 630, shown mounted to the upper latch mount 980, which secures the upper latching assembly 510 to the UAV 100. The upper latch mount 980 includes a receiver 981 for accepting and positioning the latch bearing associated with a lower latch within the dock 625. A sensor 982, such as a hall sensor, is located at the apex of the receiver 981 to detect and report when the latch bearing is seated in the dock 625. A linear actuator 990 is secured to the mount and configured to mechanically interact with the actuator cam (not shown). When activated, the actuator 990 moves the actuator cam, causing the upper latch cam to release to the open position, also referred to as the open dock configuration. A potentiometer senses the position of the actuator. In one embodiment the various sensors and the actuator/potentiometer 990 are connected to a latch control module that includes a microcontroller. The latch control module monitors and manages latch operation for autonomous latching.

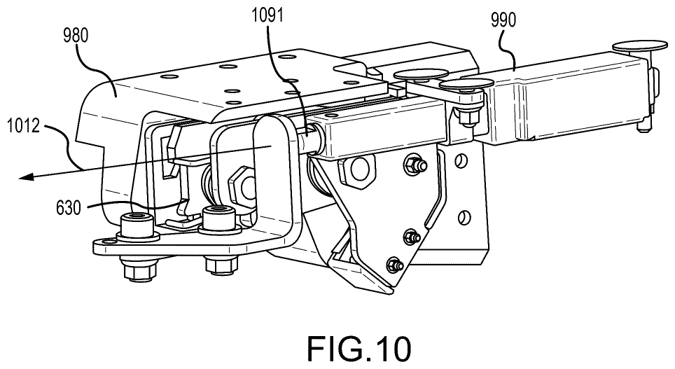

FIG. 10 shows an opposite exterior view of the upper latching assembly 510 secured to the upper latch mount 980. The linear actuator 990 includes an actuator arm 1091 for releasing the upper latch cam 630 from a closed position/closed dock configuration. When actuated, the actuator arm 1091 extends in the direction of the arrow 1012 to release the upper latch cam 630 and striker cam (not shown), allowing the upper latch(ing) assembly release thereby allowing the pod to detach from the UAV.

With reference to FIG. 11, an exploded view of an upper latching assembly can be seen, according to one embodiment of the present invention. The explode view illustrates the relationship between the striker cam 620 and the dock 625 in view of the actuator 990 and actuator arm 1091. The sensor mount 760 on which resides the first limit switch 872 and the second limit switch 874 join with the latch sensor 982 to provide signals processed by the processor to determine the state of each upper latch assembly and whether within the dock reside a latch bearing of a lower latch.

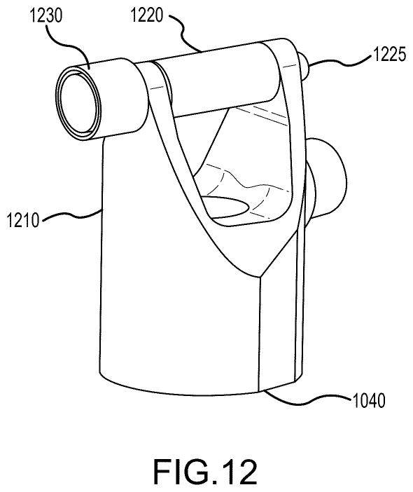

With reference to FIG. 12 is shown a perspective view of one embodiment of a lower latch or hasp 1210. The lower latch includes a latch bearing 1220 that is configured to fit inside the dock (FIG. 6, item 625) when the upper latching assembly is closed, and which is configured to mechanically interact with the receiver (FIG. 9, item 981) to properly position the pod for mounting to the UAV. The latch bearing 1220 is secured in place by a bearing pin 1225, which also provides, in one embodiment, a mounting location for a magnet 1230. The magnet 1230 establishes a magnetic field that, when in proximity, activates a sensor (FIG. 9 item 982) that detects when the lower latch bearing (and by association the lower latch) is seated in the dock 625 of the upper latching assembly 510. By ensuring and sensing that the latch bearing is properly seated in the receiver, the interaction of each upper latching assembly with the corresponding lower latch provides positive confirmation that the pod is in the correct position and properly mated with the UAV. Without sensor confirmation of the latch bearing's proper seating in the receiver, the upper latching assembly could close with the pod in the wrong position, which could put the aircraft at risk.

When the lower latch is brought into contact with the striker cam 620 of the upper latch 510, the latch bearing 1020 mechanically interacts with and rotates the striker cam 620 and latch cam 630, pressing them into the closed position, where they automatically lock the lower latch in place (closed dock configuration). A base of the lower latch 1240 is configured to mechanically interact with a mounting bracket or hard point 325 located on the pod to secure each lower latch to the pod. The combination of the hall sensor (FIG. 9 item 982) and the striker cam switches (FIG. 8, items 872, 874), along with the designed structure ensure that a pod is securely attached to the UAV without the need to be verified by an individual, thereby allowing autonomous operations.

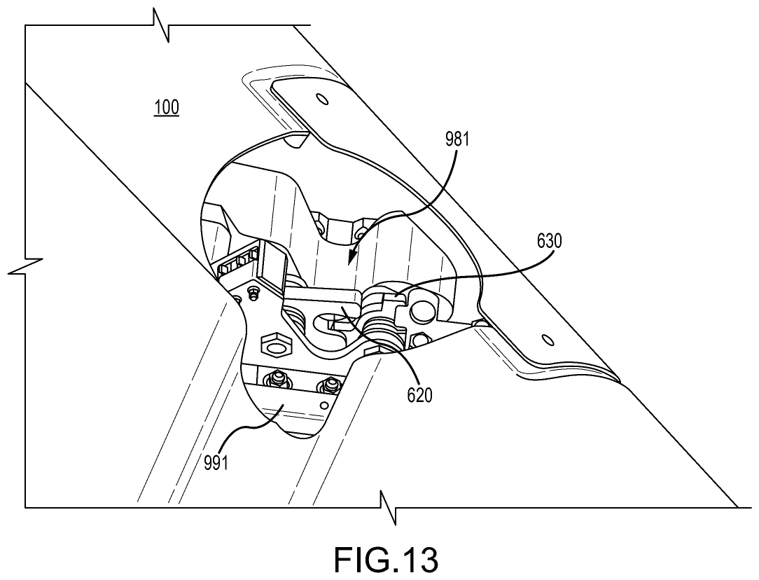

With reference to FIG. 13, an upper latch 510 is shown secured to the underside of the UAV 100. Visible are the upper latch mount 1180, the receiver 1181 and hall sensor 1182. Also visible are the sensor rocker 1170, the actuator rocker 1192, and a portion of the actuator arm 1191. The striker cam 1120 and other portions of the latch are also shown in the closed position.

What follows is a summary of components comprising the disclosed autonomous latching system:
Upper Latch mechanism (×4)
   Pod subframe
   Latch (×1)
   Limit switches (×2)—sensor for latch position
   Linear Actuator w/potentiometer (×1)—used to actuate the latch, potentiometer tells actuator position
   Hall Sensor for Lower latch Presence sensing (×1)—provides positive confirmation that the pod is correctly latched
   Manual release
   Mounting brackets and hardware
Latch Control Module (×1)
   Latch board (×1)—custom PCB incorporating electronics required for autonomous latching
   Microcontroller board (×1)—microprocessor that controls the system and communicates with higher level autonomy computer
   Protective enclosure
   Mounting hardware
Harnesses connecting Latch Control Module to 28V power, the latch mechanisms and the vehicle control computer
Lower latch mechanism or hasp (×4) that are mounted on the pod and mate with the upper latches

The invention also includes the software for the microprocessor that processes the inputs from the sensors and communicates with the vehicle computer to receive commands and provide feedback. The software communicates with, in one embodiment, User Datagram Protocol (UDP) messages with the message structure defined in JavaScript Object Notation (JSON).

The autonomous latching system described herein depicts a four-latch design. Recognizing that a four-latch design over-constrains the cargo pod and reduces flexibility while increasing difficulty of autonomous operations, alternative designs are contemplated to simplify the latch configuration.

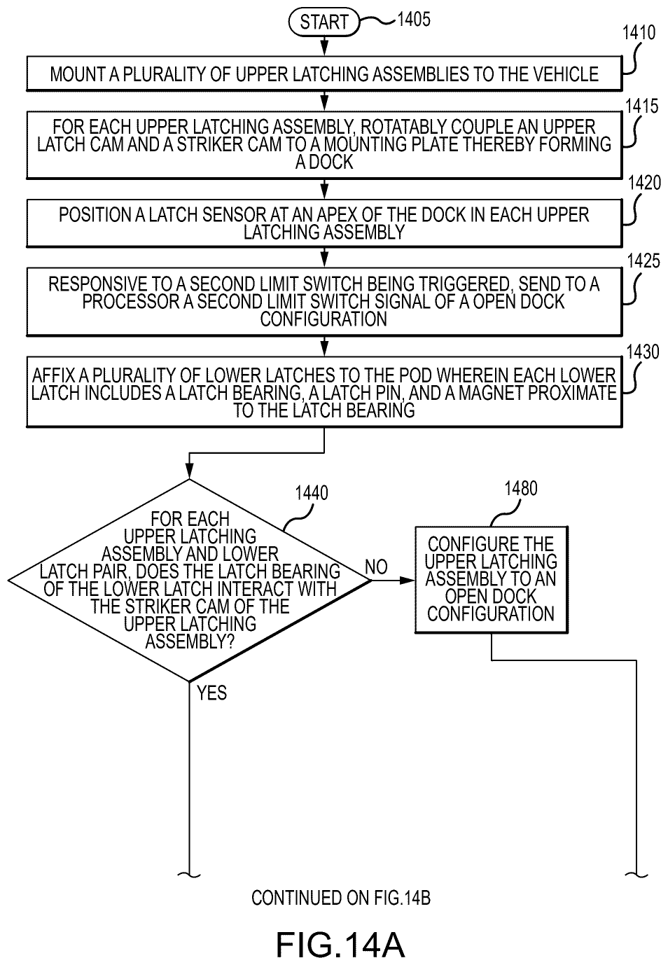

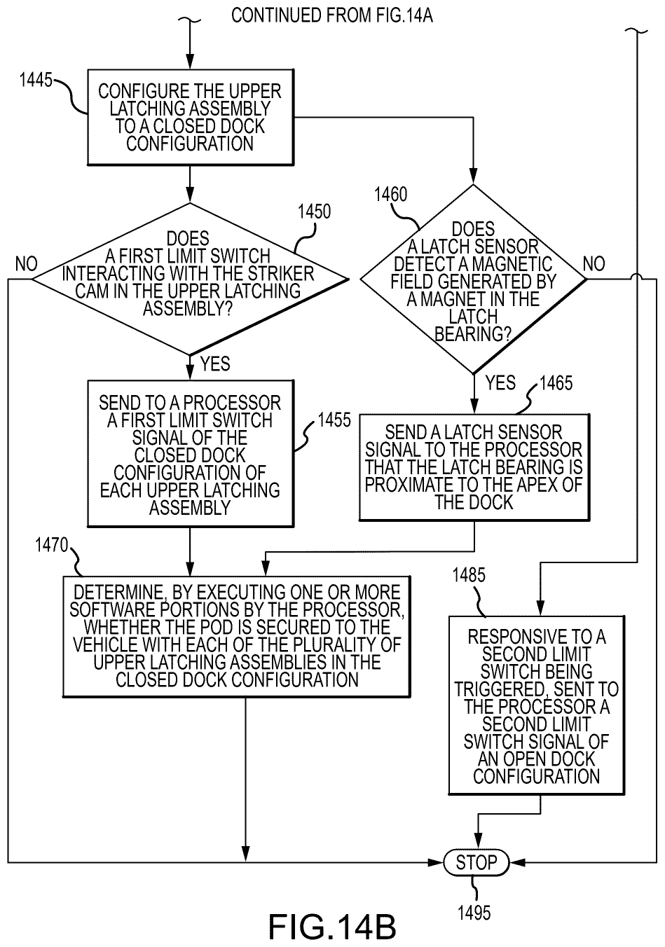

FIGS. 14A and 14B present, according to the present invention, one embodiment of a methodology for autonomously latching a cargo pod to a UAV. As described herein and according to one embodiment of the present invention, a vehicle such as a UAV includes a plurality of upper latching assemblies. Each upper latching assembly is biased to the open dock configuration 1480. A cargo pod or the like includes a corresponding number of lower latches. As the cargo pod is aligned with and encounters the UAV, a portion of each lower assembly, in one embodiment the latch bearing, interacts with portions of the corresponding upper latching assembly. The interaction drives the upper latching assembly to a closed dock configuration capturing the latch bearing within the dock. For each upper latching assembly, a proximity sensor confirms that the lower latch bearing is within dock and a limit switch confirms that upper latch is in the closed dock configuration.

The flowchart of FIGS. 14A and 14B begin 1405 with mounting 1410 a plurality of upper latching assemblies to the vehicle. As described herein, for each upper latching assembly a dock is formed 1415 by rotatably coupling to a mounting plate an upper latch cam and a striker cam. Included in each upper latching assembly is a latch sensor positioned 1420 at the apex of the dock configured to sense the presence of a latch bearing associated with a lower latch.

Each upper latching assembly also includes a first limit switch that sends to a processor, in response to the first limit switch being triggered 1425, a signal of a closed dock configuration. Similarly, each upper latching assembly includes a second limit switch that sends 1485 a signal to the processor, in response to the second limit switch being triggered 1480, a signal of an open dock configuration.

To mount a pod to a UAV each upper latching assembly must be in the open dock configuration. Accordingly, responsive to the second limit switch being triggered, a second limit switch signal is sent to the processor informing the processor of the open dock configuration of each upper latching assembly.

As the pod is aligned with and retracted toward the UAV, each of a plurality of lower latches, associated with and affixed 1430 to the pod, is aligned with and directed to interact with a corresponding upper latching assembly forming an upper latching assembly/lower latch pair. Each lower latch is affixed to the pod and includes a latch bearing, latch pin, and a magnet proximate to the latch bearing.

When the latch bearing of one of the lower latches interacts 1440 with the striker cam of one of the upper latching assemblies, the striker cam and the upper latch cam rotate placing and locking (configuring) 1445 the upper latch cam in a closed dock configuration capturing the latch bearing. The rotation of the striker cam triggers 1450 a first limit switch thereby sending 1455 a first limit switch signal to the processor that that representative upper latching assembly is in the closed dock configuration. Concurrently, when the latch bearing of one of the lower latches resides within the dock of one of the upper latching assemblies, and proximate to the latch sensor associated with that upper latching assembly, the latch sensor senses a magnetic field generated by the magnet associated with the latch bearing. Sensing 1460 the presence of the magnet associated with the latch bearing of a lower latch, the latch sensor sends 1465 a latch sensor signal to the processor that a latch bearing is present within the dock of the representative upper latch assembly

A signal combination, received at the processor from a representative upper latching assembly, of an affirmative closed dock configuration and an affirmative presence of a latch bearing in the dock and negative (lack) of a signal from the first limit sensor of an open dock configuration, enables the processor to determine 1470 that the representative latching assembly has captured the latch bearing associated with the pod. Upon receiving similar signal combinations from each of the plurality of latching assemblies, a software portion, executed by the processor concludes that the pod is secured to the UAV ending the process 1495.

As the pod is lifted, each lower latch bearing on the pod will push the corresponding upper latching assembly into the closed position/closed dock configuration. Once each of the plurality of upper latching assemblies are fully closed and confirmed in the closed dock configuration, and each latch senor signals that a latch bearing is present in the dock, the winches (part of the greater cargo handling system) can release tension so the load (pod) rests on the latches, and the aircraft can be cleared for flight.

When the UAV reaches its destination, the winches pull tension into the webbing again to prepare for opening of the upper latching assemblies. Each upper latching assembly is opened by the linear actuator, which is actuated precisely to prevent damaging the trigger mechanism. When an upper latching assembly is opened by the linear actuator, the striker cam and upper latch cam are initially prevented from rotating to the open position by the lower latch bearing. The position of the actuator provides data to the processor that each upper latching assembly is unlocked and the pod is ready to be lowered.

Once all four upper latching assemblies, including the actuator, are confirmed to be in the proper position, the winches would be cleared to lower the pod. Once the pod is lowered, the linear actuator would be retracted and the upper latching assemblies would remain in the open position till the lower latch bearing (or something else) pushes on the latch to close it.

The position of the actuator during its stroke is provided by a potentiometer communicated to the processor. The actuator releases the striker cam by pushing the actuator cam to thereby open the latch cam and release the striker cam.

It will also be understood by those familiar with the art, that the invention may be embodied in other specific forms without departing from the spirit or essential characteristics thereof. Likewise, the naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

In a preferred embodiment, portions of the present invention can be implemented in software. Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, or the like. The code may be distributed on such media or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform tasks or implement particular abstract data types. Moreover, those skilled in the art will appreciate that the invention can be practiced with other computer system configurations, including hand-held devices, multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be in both local and remote memory storage devices.

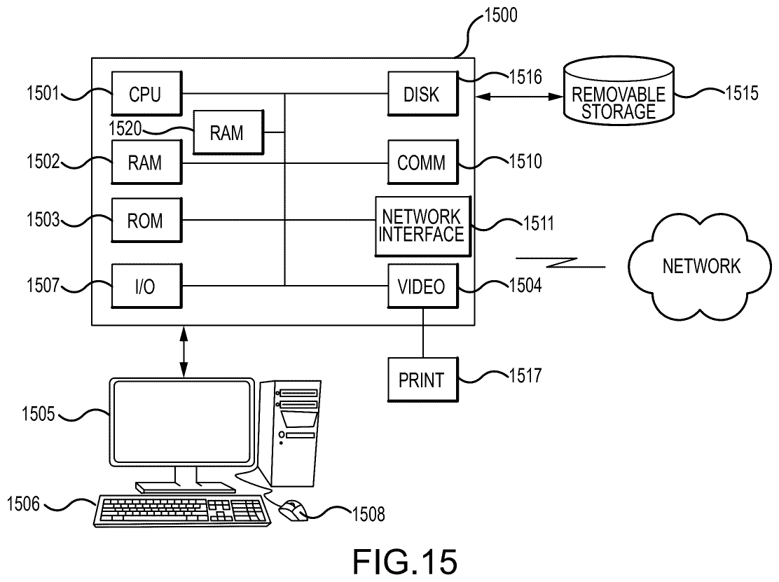

One of reasonable skill will also recognize that portions of the present invention may be implemented on a conventional or general-purpose computing system, such as a personal computer (PC), server, a laptop computer, a notebook computer, of the like. FIG. 15 is a very general block diagram of a computer system in which software-implemented processes of the present invention may be embodied. As shown, system 1500 comprises a central processing unit(s) (CPU) or processor(s) 1501 coupled to a random-access memory (RAM) 1502, a graphics processor unit(s) (GPU) 1120, a read-only memory (ROM) 1503, a keyboard or user interface 1506, a display or video adapter 1504 connected to a display device 1505, a removable (mass) storage device 1515 (e.g., floppy disk, CD-ROM, CD-R, CD-RW, DVD, or the like), a fixed (mass) storage device 1516 (e.g., hard disk), a communication (COMM) port(s) or interface(s) 1150, and a network interface card (NIC) or controller 1511 (e.g., Ethernet, WIFI). Although not shown separately, a real time system clock is included with the system 1500, in a conventional manner.

CPU 1501 comprises a suitable processor for implementing the present invention. The CPU 1501 communicates with other components of the system via a bi-directional system bus 1120 (including any necessary input/output (I/O) controller 1507 circuitry and other “glue” logic). The bus, which includes address lines for addressing system memory, provides data transfer between and among the various components. Random-access memory 1502 serves as the working memory for the CPU 1501. The read-only memory (ROM) 1503 contains the basic input/output system code (BIOS)—a set of low-level routines in the ROM that application programs and the operating systems can use to interact with the hardware, including reading characters from the keyboard, outputting characters to printers, and so forth.

Mass storage devices 1515, 1516 provide persistent storage on fixed and removable media, such as magnetic, optical, or magnetic-optical storage systems, flash memory, or any other available mass storage technology. The mass storage may be shared on a network, or it may be a dedicated mass storage. As shown in FIG. 15, fixed storage 1516 stores a body of program and data for directing operation of the computer system, including an operating system, user application programs, driver and other support files, as well as other data files of all sorts. Typically, the fixed storage 1516 serves as the main hard disk for the system.

In basic operation, program logic (including that which implements methodology of the present invention described below) is loaded from the removable storage 1515 or fixed storage 1516 into the main (RAM) memory 1502, for execution by the CPU 1501. During operation of the program logic, the system 1500 accepts user input from a keyboard and pointing device 1506, as well as speech-based input from a voice recognition system (not shown). The user interface 1506 permits selection of application programs, entry of keyboard-based input or data, and selection and manipulation of individual data objects displayed on the screen or display device 1505. Likewise, the pointing device 1508, such as a mouse, track ball, pen device, or the like, permits selection and manipulation of objects on the display device. In this manner, these input devices support manual user input for any process running on the system.

The computer system 1500 displays text and/or graphic images and other data on the display device 1505. The video adapter 1504, which is interposed between the display 1505 and the system's bus, drives the display device 1505. The video adapter 1504, which includes video memory accessible to the CPU 1501, provides circuitry that converts pixel data stored in the video memory to a raster signal suitable for use by a cathode ray tube (CRT) raster or liquid crystal display (LCD) monitor. A hard copy of the displayed information, or other information within the system 1500, may be obtained from the printer 1517, or other output device.

The system itself communicates with other devices (e.g., other computers) via the network interface card (NIC) 1511 connected to a network (e.g., Ethernet network, Bluetooth wireless network, or the like). The system 1500 may also communicate with local occasionally connected devices (e.g., serial cable-linked devices) via the communication (COMM) interface 1150, which may include a RS-232 serial port, a Universal Serial Bus (USB) interface, or the like. Devices that will be commonly connected locally to the interface 1510 include laptop computers, handheld organizers, digital cameras, and the like.

While there have been described above the principles of the present invention in conjunction with an autonomous latching system and associated methodology, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. An autonomous latching system, comprising
a processor capable of executing instructions embodied as software;
a plurality of upper latching assemblies mounted to a vehicle wherein each upper latching assembly includes
an upper latch cam,
a striker cam, wherein the upper latch cam and the striker cam are rotatably coupled to a mounting plate and rotatably interact to form a dock,
a first limit switch wherein responsive to the first limit switch interacting with the striker cam the first limit switch sends a first limit switch signal to the processor of a closed dock configuration, and
a latch sensor;
a plurality of lower latches affixed to a pod wherein each lower latch includes a latch bearing, a latch pin and a magnet proximate to the latch bearing wherein responsive to the latch bearing interacting with the striker cam, the lower latch resides within the dock of the upper latching assembly in the closed dock configuration; and
one or more software portions wherein one of said software portions is configured to determine whether the pod is secured to the vehicle with each of the plurality of upper latching assemblies in the closed dock configuration.

2. The autonomous latching system of claim 1, further including a pair of springs interposed between the mounting plate and the upper latch cam and the striker cam and biased to hold the striker cam and the upper latch cam in the open dock configuration.

3. The autonomous latching system of claim 1, wherein the latch sensor is positioned at an apex of the dock and wherein the latch sensor is a hall sensor.

4. The autonomous latching system of claim 1, wherein responsive to the latch sensor detecting the latch bearing the latch sensor sends a latch sensor signal to the processor that the latch bearing is proximate to the apex of the dock.

5. The autonomous latching system of claim 1, wherein the upper latch cam includes a recess and responsive to the latch bearing interacting with the striker cam the striker cam and the upper latch cam rotate and a portion of the striker cam is captured by the recess in the upper latch cam thereby locking the upper latching assembly in the closed dock configuration.

6. The autonomous latching system of claim 1, wherein one of said software portions is configured to determine, in each upper latching assembly, when upper latching assembly is in the closed configuration and the latch bearing is proximate to the apex of the dock.

7. The autonomous latching system of claim 1, further comprising a second limit switch wherein responsive to the second limit switch interacting with the striker cam the second limit switch sends a second limit switch signal to the processor of the open dock configuration.

8. The autonomous latching system of claim 7, wherein one of said software portions is configured to receive signals from each first limit switch, each the second limit switch and each latch sensor to confirm a status of each upper latching assembly and proximity of each latch bearing.

9. The autonomous latching system of claim 8, further comprising an actuator wherein responsive to the actuator interacting with an actuator cam the actuator cam rotates the upper latch cam to release the striker cam, and the upper latch cam, to an open dock configuration.

10. The autonomous latching system of claim 9, wherein one of said software portions is configured send a signal to the actuator to rotate the trigger cam and place each of the plurality of upper latching assemblies in the open dock configuration.

11. A method of autonomous latching a pod to a vehicle, the method comprising:
mounting a plurality of upper latching assemblies to the vehicle wherein each upper latching assembly includes an upper latch cam, a striker cam, and a mounting plate;
for each upper latching assembly, rotatably coupling the upper latch cam and the striker cam to the mounting plate wherein responsive to the upper latch cam and the striker cam rotatably interacting, forming a dock;
positioning a latch sensor in each upper latching assembly;
affixing a plurality of lower latches to the pod wherein each lower latch includes a latch bearing, a latch pin, and a magnet proximate to the latch bearing;
responsive to the latch bearing of one of the plurality of lower latches interacting with the striker cam of one of the plurality of upper latching assemblies and residing within the dock of that upper latching assembly, configuring that upper latching assembly to a closed dock configuration;
responsive to a first limit switch interacting with the striker in each upper latching assembly, sending to a processor a first limit switch signal of the closed dock configuration, wherein the processor is capable of executing instructions embodied as software; and
determining, by executing one or more software portions by the processor, whether the pod is secured to the vehicle with each the latch bearings of the plurality of lower latches residing within the dock and each of the plurality of upper latching assemblies in the closed dock configuration.

12. The method of autonomous latching a pod to a vehicle of claim 11, further including interposing a pair of springs between the mounting plate and the upper latch cam and the striker cam biased to hold the striker cam and the upper latch cam in an open dock configuration.

13. The method of autonomous latching a pod to a vehicle of claim 11, further comprising detecting, by the latch sensor, a magnetic field generated by the magnet. at an apex of the dock.

14. The method of autonomous latching a pod to a vehicle of claim 11, responsive to detecting the magnetic field, further comprising sending a latch sensor signal to the processor that the latch bearing is proximate to the apex of the dock.

15. The method of autonomous latching a pod to a vehicle of claim 11, responsive to the latch bearing of one of the plurality of lower latches interacting with the striker cam of one of the plurality of upper latching assemblies, further comprising capturing a portion of the striker cam by a recess in the upper latch cam thereby locking the upper latching assembly in the closed dock configuration.

16. The method of autonomous latching a pod to a vehicle of claim 11, further comprising, determining for each upper latching assembly, by executing one or more software portions by the processor, when upper latching assembly is in the closed configuration and when latch bearing is proximate to the apex of the dock.

17. The method of autonomous latching a pod to a vehicle of claim 11, responsive to a second limit switch interacting with the striker cam, further comprising sending a second limit switch signal to the processor of an open dock configuration.

18. The method of autonomous latching a pod to a vehicle of claim 17, further comprising receiving by the processor from each of the plurality of latching assemblies, the first limit switch signal, the second limit switch signal and a latch sensor signal.

19. The method of autonomous latching a pod to a vehicle of claim 18, further comprising confirming for each upper latching assembly, by executing one or more software portions by the processor, whether each upper latching assembly is in the closed dock configuration and whether the latch bearing is proximate to the apex of the dock.

20. The method of autonomous latching a pod to a vehicle of claim 19, responsive to an actuator interacting with an actuator cam by way of a trigger cam, further comprising rotating the upper latch cam thereby releasing the striker cam, and the upper latch cam, forming an open dock configuration.

21. The method of autonomous latching a pod to a vehicle of claim 20, further comprising, sending a signal, by executing one or more software portions by the processor, the actuator of each upper latching assembly to rotate the upper latch cam placing each of the plurality of upper latching assemblies in the open dock configuration.
